(19) United States
(12) Patent Application Publication
(10) Pub. No.: US 2003/0079534 A1
(43) Pub. Date: May 1, 2003

(54) Pressure indicating device for tire

(76) Inventor: Mu-Chuan Hsu, Taipei (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/046,419

(22) Filed: Oct. 29, 2001

(51) Int. Cl. G01M 17/02

(52) U.S. Cl. 73/146

(57) ABSTRACT

An apparatus for indicating a pressure of a tire comprises a pressure indicator within tire being in communication with air therein, a hollow cylindrical scale member projected from tire, scale member having one end in communication with pressure indicator and the other end enclosed, scale member being formed of transparent plastic, and scale member further having a scale on its outer peripheral surface, and a bellow member within scale member, bellow member being formed of elastic material having a wavy peripheral section urged against an inner periphery of scale member by the pressure of tire Top of bellow member may lift or lower as the pressure of tire changes Also, top of bellow member is aligned with one of marks of scale

### FIELD OF THE INVENTION

The present invention relates to tires of motor vehicle and more particularly to a pressure indicating device for tire of motor vehicle with improved characteristics

### BACKGROUND OF THE INVENTION

Conventionally, a person can know the fullness of a tire of an automobile being inflated by observing the pivoting of pointer of a pressure gauge coupled to an air pump However, person can only knock on the tire by hand or foot for generally determining a fullness thereof by feeling its hardness or hearing its sound prior to driving. However, such technique is not reliable. Thus improvement exists

### SUMMARY OF THE INVENTION

It is therefore an object of the present invention to provide an apparatus for indicating a pressure of a tire comprising a pressure indicator within the tire being in communication with air therein, a hollow cylindrical scale member projected from the tire, the scale member having one end in communication with the pressure indicator and the other end enclosed, the scale member being formed of transparent plastic, and the scale member further having a scale on its outer peripheral surface, and a bellow member within the scale member, the bellow member being formed of elastic material having a wavy peripheral section urged against an inner periphery of the scale member by the pressure of the tire, wherein a top of the bellow member is operative to lift or lower as the pressure of the tire changes, and the top of the bellow member is aligned with one of marks of the scale.

The above and other objects, features and advantages of the present invention will become apparent from the following detailed description taken with the accompanying drawings

### BRIEF DESCRIPTION OF THE DRAWINGS

FIG. 1 is a side view showing a wheel with fixed tire incorporating a pressure indicating device according to the invention,

FIG. 2 is a cross-sectional view of scale member mounted on one end of pressure indicating device with a greatly enlarged fragmentary view on lower part showing the area in circle,

FIG. 3 is a cross-sectional view of the scale member with bellow member being expanded by inflated air: and

FIG. 4 is a perspective view showing the enlarged pressure indicating device of FIG. 1

### DETAILED DESCRIPTION OF THE PREFERRED EMBODIMENTS

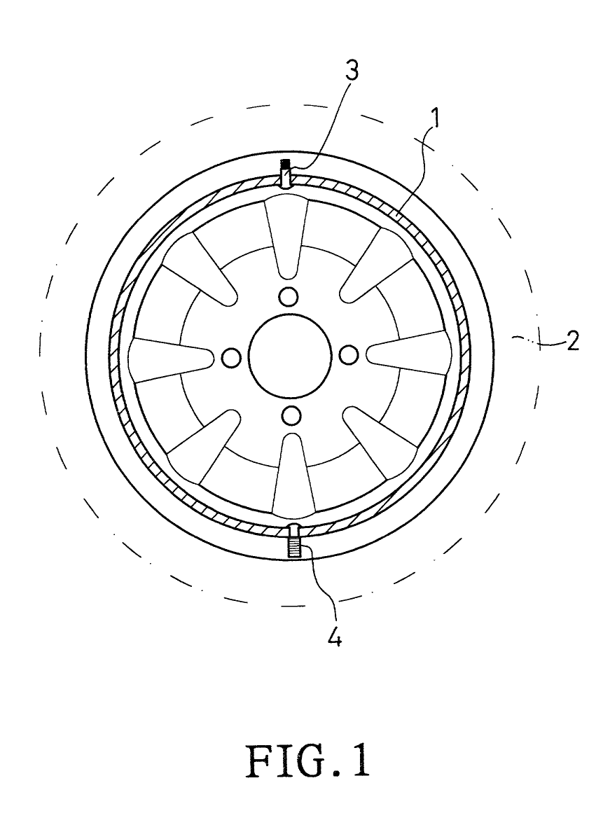

Referring to FIG. 1, there is shown a wheel having a tire 2 fixed about rim 1, a valve 3 through rim 1 for pumping air into tire 2, a pressure indicating device 4 within tire 2 being in communication with air therein, and a scale member 5 through and projected from rim 1, scale member 5 being coupled to one end of pressure indicating device 4 in which both pressure indicating device 4 and scale member 5 are constructed in accordance with the invention

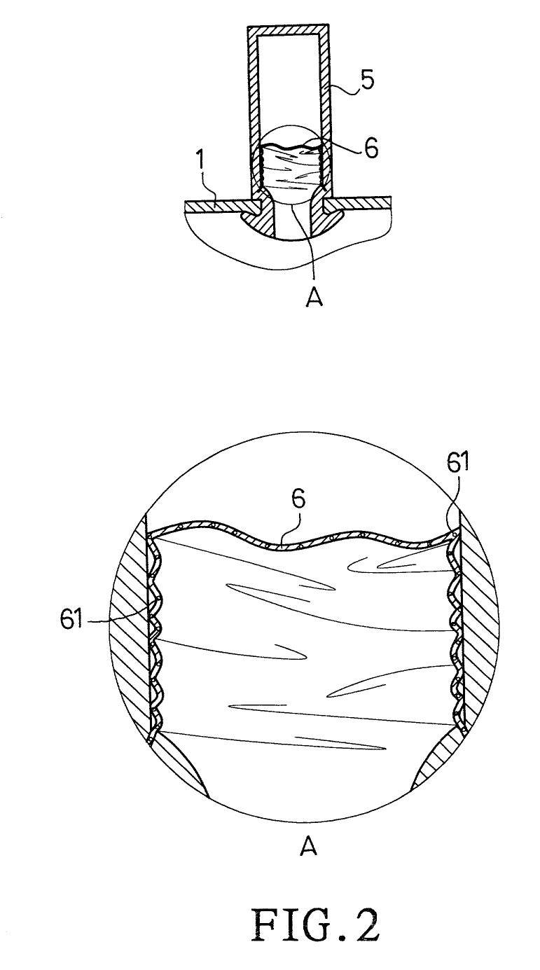

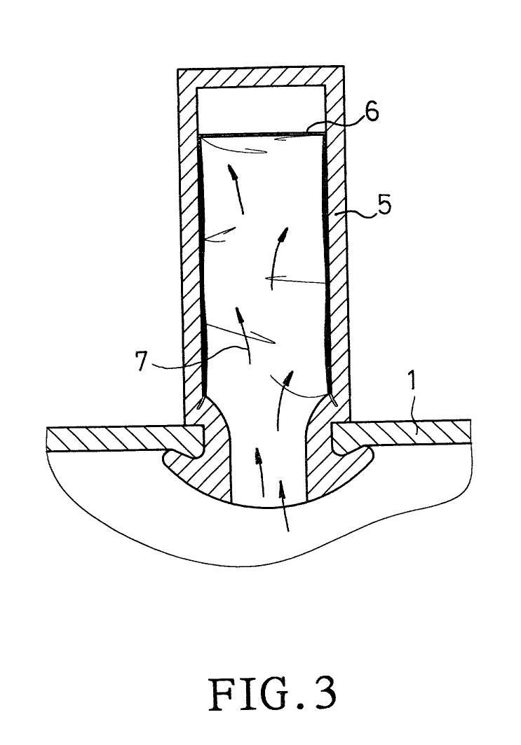

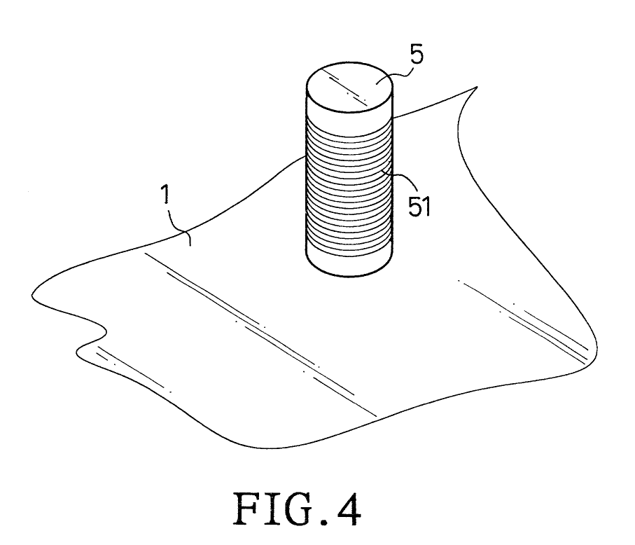

Referring to FIGS. 2 to 4, pressure indicating device 4 and scale member 5 will be described in detail below Scale member 5 is a hollow cylinder with top (i.e., outer end) enclosed Scale member 5 is formed of hard, transparent plastic material. Scale member 5 has a plurality of parallel circles on its outer peripheral surface as graduated scale 51 In a preferred embodiment, the unit of scale is represented as a predetermined pound(s) per square inch (psi) or kilopascal(s) per square centimeter (kPa) Within scale member 5, there is provided a bellow member 6 Bellow member 6 is formed of strong elastic material having its wavy peripheral section 61 urged against the inner periphery of scale member 5 by the pressure of air of tire 2. Also, top of bellow member 6 may lift or lower due to the nature of elastic material as the pressure of air of tire 2 changes. In use, prior to driving person (e.g. driver) can know the pressure of tire 2 by observing the top of bellow member 6 which is aligned with a certain scale 51 between a maximum value and a minimum value.

While the invention has been described by means of specific embodiments, numerous modifications and variations could be made thereto by those skilled in the art without departing from the scope and spirit of the invention set forth in the claims.

What is claimed is:

1 An apparatus for indicating a pressure of a tire comprising.
a pressure indicator within the tire being in communication with air therein,
a hollow cylindrical scale member projected from the tire, the scale member having one end in communication with the pressure indicator and the other end enclosed, the scale member being formed of transparent plastic, and the scale member further having a scale on its outer peripheral surface and
a bellow member within the scale member, the bellow member being formed of elastic material having a wavy peripheral section urged against an inner periphery of the scale member by the pressure of the tire,
wherein a top of the bellow member is operative to lift or lower as the pressure of the tire changes, and the top of the bellow member is aligned with one of marks of the scale
